(19) United States
(12) Patent Application Publication
(10) Pub. No.: US 2026/0347037 A1
(43) Pub. Date: Nov. 5, 2026

(54) FLATTENING DEVICE FOR BAGGED PACKAGING PRODUCTS

(71) Applicant: CJ CHEILJEDANG CORPORATION, Seoul (KR)

(72) Inventors: Rae Yong LEE, Seoul (KR); Il Seok KWON, Seoul (KR); Yong Bok SEOK, Seoul (KR); Seung Kyu KANG, Seoul (KR)

(73) Assignee: CJ CHEILJEDANG CORPORATION, Seoul (KR)

(21) Appl. No.: 19/485,267

(22) PCT Filed: May 17, 2024
(86) PCT No.: PCT/KR2024/006746

§ 371 Date: Nov. 17, 2025

(30) Foreign Application Priority Data
May 18, 2023 (KR) 10-2023-0064106

(51) Int. Cl. B65B 61/24; B65G 21/20

(52) U.S. Cl. CPC B65B 61/24; B65G 21/209; B65G 2201/0238

(57) ABSTRACT

Disclosed is a flattening device comprising a belt conveyor, a second rotary roller, a conveyor belt, a first main gear, and a first drive motorp.

### CROSS-REFERENCE TO RELATED APPLICATION

This application claims priority to and the benefit of Korean Patent Application No. 10-2023-0064106 filed in the Korean Intellectual Property Office on May 18, 2023, the entire contents of which are incorporated herein by reference.

### TECHNICAL FIELD

The present disclosure relates to a flattening device for bagged packaging products that flattens surfaces of bagged packaging products to be level during a process of transferring the bagged packaging products by means of a conveyor, and more particularly, to a flattening device for bagged packaging products, the flattening device being capable of gradually flattening surfaces of bagged packaging products by applying an external force to the surfaces of the bagged packaging products during a process of transferring the bagged packaging products by means of a conveyor in order to alleviate deformation of the bagged packaging products in which contents are concentrated in a partial region in a packaging bag.

### BACKGROUND ART

In general, sealed plastic packaging bags are bags having therein spaces formed by thermally bonding edges of two or three sheets of various types of publicly-known plastic compounds such as polypropylene (PP) and polyethylene (PE).

These sealed plastic packaging bags are classified into various types, such as pouches and self-standing sealed plastic packaging bags, depending on the use thereof and used to package and store liquid or gel-like fillers such as beverages, detergents, fabric softeners, soybean paste, and chili paste in internal spaces thereof.

In addition, the sealed plastic packaging bags are used as refill containers or the like and substituted for glass bottles, cans, plastic containers, and the like because the sealed plastic packaging bags are easily portable and low in packaging costs. In particular, the sealed plastic packaging bags are used as packaging bags for packaging frozen drinks and food items such as dumplings.

However, in case that frozen food items are packaged in a sealed plastic packaging bag, there may occur a problem in that the frozen food items are clumped in a partial space without being uniformly distributed in the sealed plastic packaging bag during a process in which the frozen food items are loaded into the sealed plastic packaging bag.

In addition, in case that the bagged packaging products configured by packaging the frozen food items in the sealed plastic packaging bags have uneven external shapes because of the clumped frozen food items, a process of flattening the bagged packaging products is required to stack the bagged packaging products in a box for packaging.

FIG. 1 is a schematic view schematically illustrating an automatic packaging system in the related art.

With reference to FIG. 1, the automatic packaging system in the related art includes a flattening part 10 configured to flatten bagged packaging products, an interval adjustment part 20 configured to adjust intervals between the bagged packaging products, and a stacking part 30 configured to stack two or three bagged packaging products.

The interval adjustment part 20 includes a primary interval adjustment part 20A, a secondary interval adjustment part 20B, and a connection part 20C. The bagged packaging products adjusted to have appropriate intervals by the primary and secondary interval adjustment parts 20A and 20B are transferred to the stacking part 30 by a conveyor belt 23 that constitutes the connection part 20C.

The bagged packaging products P1 and P2 stacked as described above need to stably remain stacked without shifting until the bagged packaging products P1 and P2 are loaded into the box. However, in case that the bagged packaging products have uneven shapes, the product P1 placed on the product P2 may slip and deviate from an exact position, which may cause a problem in that the stacked products are misaligned even before the box packaging is completed.

Such an alignment defect may lead to a box packaging defect, which inevitably and significantly degrades the automation efficiency of the box packaging.

### DISCLOSURE

### Technical Problem

Accordingly, an object of the present disclosure is to provide a flattening device for bagged packaging products, the flattening device being capable of flattening bagged packaging products by automatically pressing deformed portions of the bagged packaging products to induce dispersion of contents in the bagged packaging products so that the bagged packaging products, which may be stacked on one another or partially overlap one another during a process of transferring the bagged packaging products by means of a conveyor, may be smoothly packaged during a process of loading the bagged packaging products into a packaging box.

### Technical Solution

In order to achieve the above-mentioned object of the present disclosure, one embodiment of the present disclosure provides a flattening device for bagged packaging products, the flattening device including: a belt conveyor including a first rotary roller installed at a front end of the conveyor and installed in a width direction of the conveyor, a second rotary roller installed rearward of the first rotary roller and installed in parallel with the first rotary roller, a conveyor belt installed to surround the first rotary roller and the second rotary roller, a first main gear installed on the first rotary roller or the second rotary roller, and a first drive motor connected to the first main gear and configured to transmit driving power; a dispersion induction unit installed in the belt conveyor and configured to supply an external force so that contents in a bagged packaging product transferred by the conveyor belt are dispersed in the bagged packaging product; and a pressing unit installed above the belt conveyor, spaced apart from the belt conveyor, and configured to press the bagged packaging product, which is transferred by the belt conveyor, in a direction toward the dispersion induction unit.

### Advantageous Effects

According to the present disclosure, impact is applied to the bagged packaging products during the process of transferring the bagged packaging products by means of the conveyor in order to naturally disperse the contents in the bagged packaging products, thereby flattening the surfaces of the bagged packaging products.

In addition, according to the present disclosure, the deformed surface of the bagged packaging product may be restored to a flat surface during the process of transferring the bagged packaging product, thereby increasing the production speed and preventing damage to the packaging bag of the bagged packaging product during the process of tightly attaching the bagged packaging products.

Further, according to the present disclosure, the pressing roller may be installed to transmit impact only to the bagged packaging product, which deforms and bends the conveyor belt, through the conveyor belt, thereby minimizing damage to the conveyor belt.

### DESCRIPTION OF DRAWINGS

FIG. 1 is a schematic view schematically illustrating an automatic packaging system in the related art.

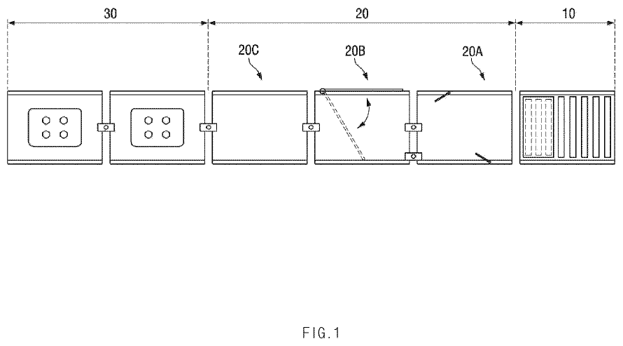

FIG. 2 is a perspective view for explaining a flattening device for bagged packaging products according to the present disclosure.

FIG. 3 is a top plan view illustrating the flattening device for bagged packaging products according to the present disclosure.

FIG. 4 is a right side view illustrating the flattening device for bagged packaging products according to the present disclosure.

FIG. 5 is a left side view illustrating the flattening device for bagged packaging products according to the present disclosure.

FIG. 6 is a cross-sectional view illustrating the flattening device for bagged packaging products according to the present disclosure.

FIG. 7 is a top plan view for explaining a pressing roller of the flattening device for bagged packaging products according to the present disclosure.

### BEST MODE

Hereinafter, a flattening device for bagged packaging products according to exemplary embodiments of the present disclosure will be described in detail with reference to the accompanying drawings.

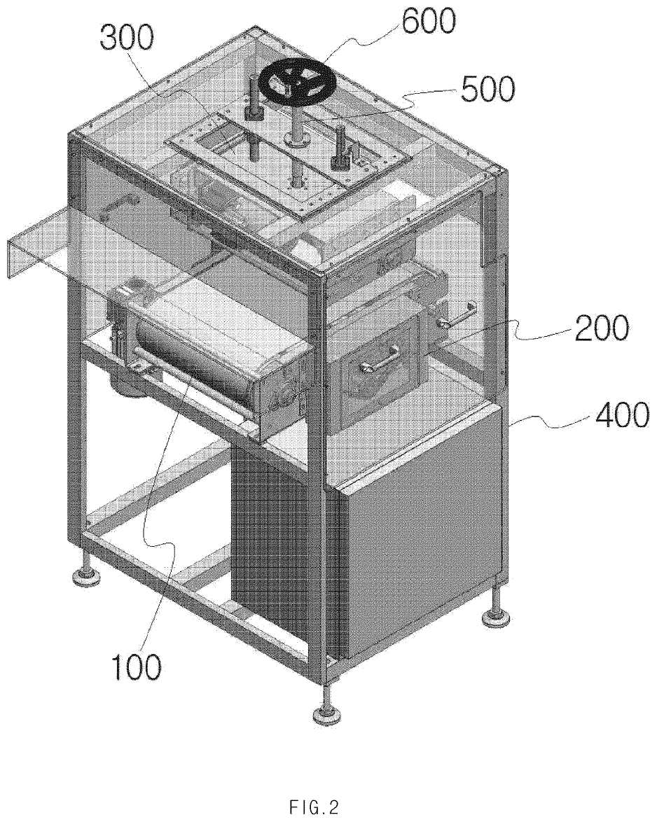

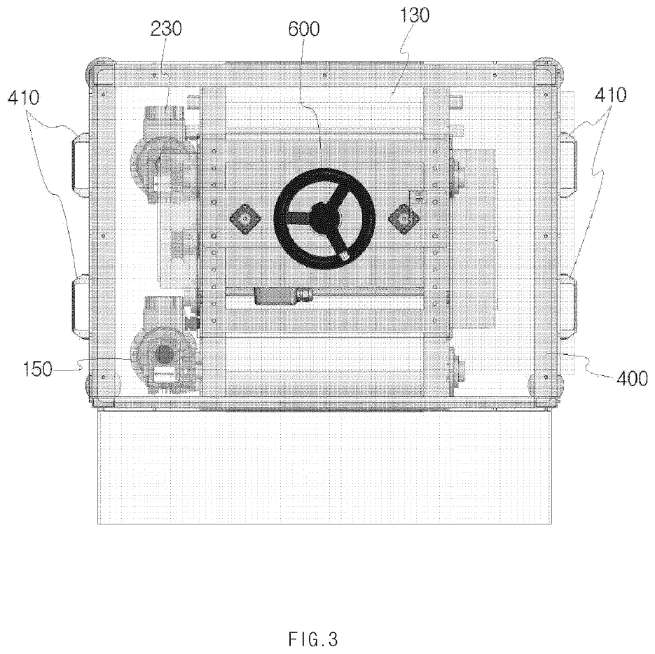

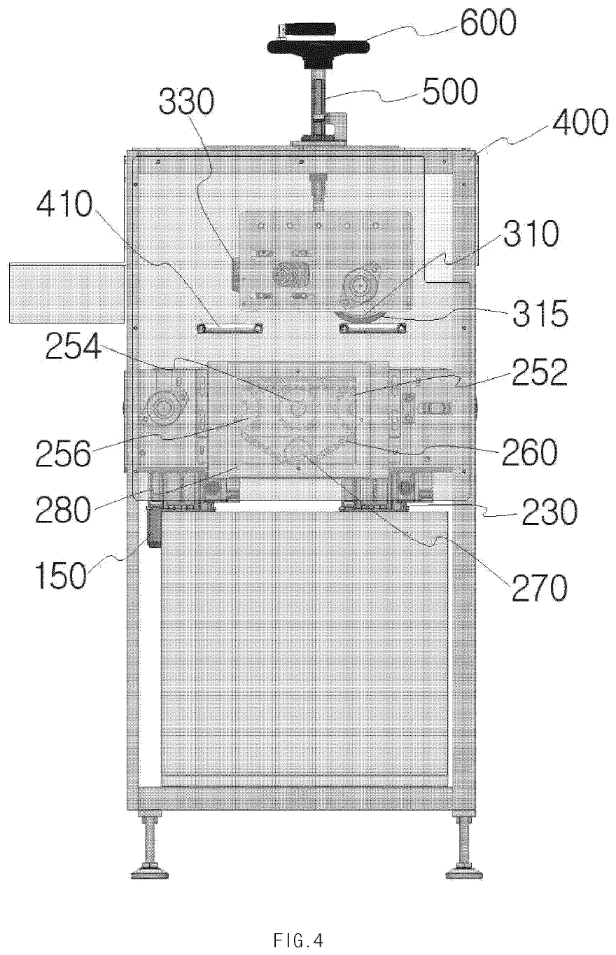

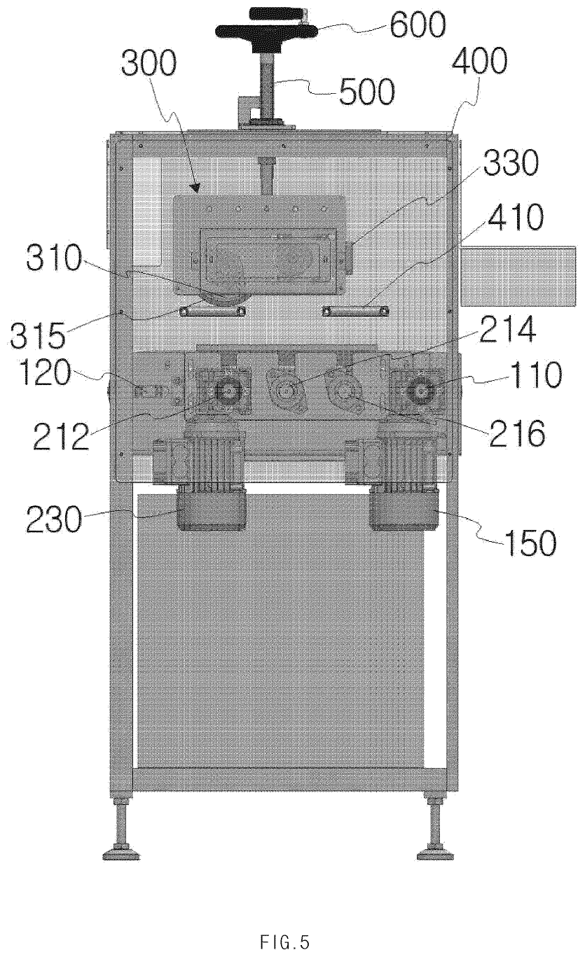

FIG. 2 is a perspective view for explaining a flattening device for bagged packaging products according to the present disclosure, FIG. 3 is a top plan view illustrating the flattening device for bagged packaging products according to the present disclosure, FIG. 4 is a right side view illustrating the flattening device for bagged packaging products according to the present disclosure, and FIG. 5 is a left side view illustrating the flattening device for bagged packaging products according to the present disclosure.

With reference to FIGS. 2 to 5, a flattening device for bagged packaging products according to the present disclosure includes a belt conveyor 100 including a first drive motor 150, a dispersion induction unit 200 installed in the belt conveyor 100 and configured to supply an external force to allow contents in the bagged packaging products, which are transferred by a conveyor belt 130, to be dispersed in the bagged packaging products, and a pressing unit 300 installed above the belt conveyor 100, spaced apart from the belt conveyor 100, and configured to press the bagged packaging products, which are transferred by the belt conveyor 100, in a direction toward the dispersion induction unit 200.

The flattening device for bagged packaging products moves the bagged packaging products supplied from a preceding conveyor, disperses the contents, which are concentrated in partial regions among the contents accommodated in the bagged packaging products, and then unloads the bagged packaging products to a subsequent conveyor.

In addition, the bagged packaging products accommodate contents, such as frozen dumplings, with hard surfaces and predetermined volumes. When the contents are concentrated in a partial space in the packaging bag during a packaging process, the packaging bag may have a curved external shape instead of a flat external shape.

Hereinafter, the constituent elements will be described more specifically with reference to the drawings.

With reference to FIGS. 2 to 5, the flattening device for bagged packaging products according to the embodiment of the present disclosure may further include an external frame 400.

The external frame 400 is configured by a plurality of frames and defines an external shape. The external frame 400 is made by coupling rectangular parallelepiped frames by means of screws and provides an installation space for the belt conveyor 100, the dispersion induction unit 200, and the pressing unit 300.

The external frame 400 includes a plurality of column frames mounted on a ground surface in a vertical direction, and a roof frame installed between the column frames to connect upper ends of the column frames.

In addition, the external frame 400 may have transparent protection plates installed around the belt conveyor 100 and the pressing unit 300 to protect the belt conveyor 100 and the pressing unit 300. The transparent protection plate may be rotatable by being hingedly coupled to the external frame 400. The transparent protection plates may be provided with handles 410 configured to receive an external force so that the transparent protection plates may be easily rotated by the external force.

Further, the external frame 400 may have spiral assembling holes formed in the upper end thereof, particularly, the roof frame.

With reference to FIGS. 2 to 5, the flattening device for bagged packaging products according to the present disclosure includes the belt conveyor 100.

The belt conveyor 100 is configured to move the bagged packaging products, which are loaded to a front end, to a rear end by rotating the conveyor belt. The belt conveyor 100 includes a first rotary roller 110 installed at the front end of the conveyor and installed in a width direction of the conveyor, a second rotary roller 120 installed rearward of the first rotary roller 110 and installed in parallel with the first rotary roller 110, the conveyor belt 130 installed to surround the first rotary roller 110 and the second rotary roller 120, a first main gear 140 installed on the first rotary roller 110 or the second rotary roller 120, and the first drive motor 150 connected to the first main gear 140 and configured to transmit driving power.

As necessary, the belt conveyor 100 may have left and right partition walls provided at two opposite left and right sides of the conveyor belt 130 and configured to provide a space in which the first rotary roller 110 and the second rotary roller 120 are seated and installed.

The first rotary roller 110 is configured to be axially rotated by driving power transmitted from the first drive motor 150. The first rotary roller 110 may include a first main roller provided to be in contact with the conveyor belt 130 and configured to rotate the conveyor belt 130, and a first center shaft protruding from centers of two opposite distal ends of the first main roller and seated on the left and right partition walls. In this case, the first center shaft is connected to bearings installed on the left and right partition walls so that the first center shaft may be axially rotated by the driving power transmitted from the first drive motor 150.

The second rotary roller 120 is configured to be axially rotated by the rotation of the conveyor belt 130 while supporting two opposite distal ends of the conveyor belt 130 together with the first rotary roller 110. The second rotary roller 120 may include a second main roller provided to be in contact with the conveyor belt 130 and configured to operate in conjunction with the rotation of the conveyor belt 130, and a second center shaft protruding from centers of two opposite distal ends of the second main roller and seated on the left and right partition walls. In this case, the second center shaft is connected to bearings installed on the left and right partition walls so that the second center shaft may be axially rotated by a rotational force transmitted from the conveyor belt 130.

The conveyor belt 130 is configured as an endless track and provides a space in which the bagged packaging products loaded from a front conveyor are to be seated. The conveyor belt 130 transfers the bagged packaging products to a rear conveyor.

The first main gear 140 is fixed to the first rotary roller 110 or the second rotary roller 120 to transmit driving power from the first drive motor 150 to the first rotary roller 110 or the second rotary roller 120. The first main gear 140 may be provided on the first rotary roller 110 or the second rotary roller 120 and disposed at the outer periphery of the conveyor belt 130. Alternatively, the first main gear 140 may be provided on the first rotary roller 110 or the second rotary roller 120 and disposed in the conveyor belt 130.

The first drive motor 150 generates driving power and transmits the driving power to the first main gear 140 through a rotary shaft pulley coupled to a rotary shaft. In this case, the rotary shaft pulley engages with the first main gear 140 and transmits driving power from the rotary shaft to the first main gear 140.

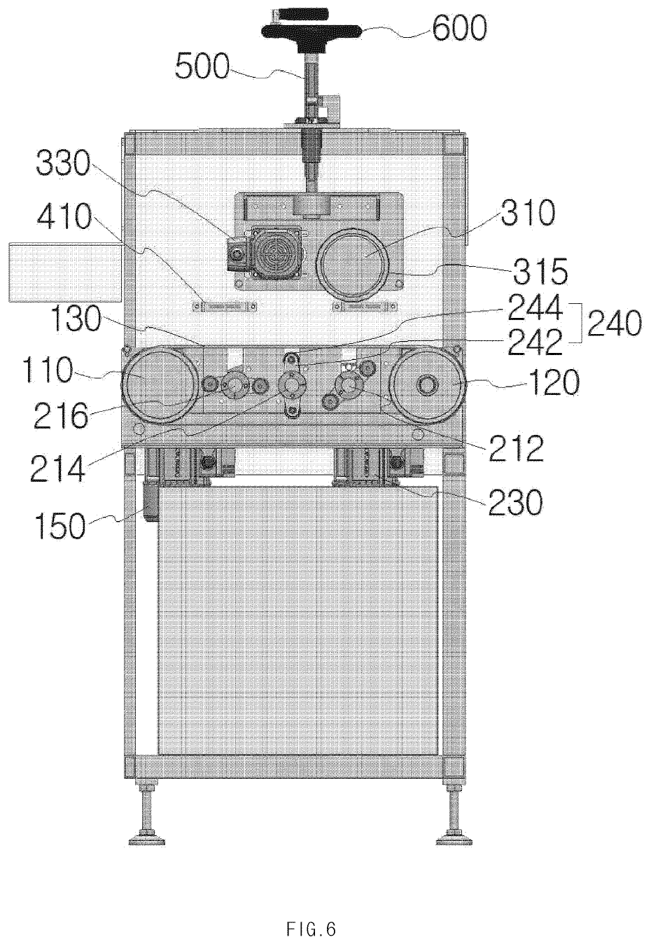

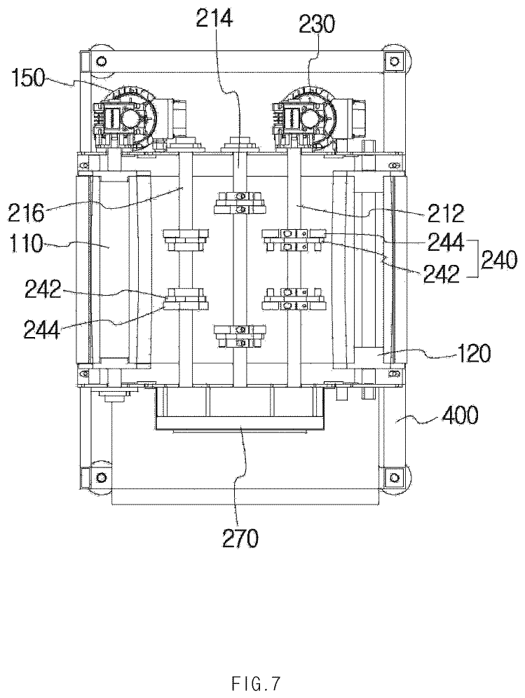

FIG. 6 is a cross-sectional view illustrating the flattening device for bagged packaging products according to the present disclosure, and FIG. 7 is a top plan view for explaining a pressing roller of the flattening device for bagged packaging products according to the present disclosure.

With reference to FIGS. 2 to 7, the flattening device for bagged packaging products according to the present disclosure includes the dispersion induction unit 200.

The dispersion induction unit 200 is installed in the convey or belt 130 and applies impact to the bagged packaging products, which press the conveyor belt 130 to a degree to which the conveyor belt 130 is bent, among the bagged packaging products that move along the conveyor belt 130.

In a first embodiment, the dispersion induction unit 200 according to the present disclosure includes a first driving shaft 212 installed at a predetermined interval between the first rotary roller 110 and the second rotary roller 120, a second main gear 220 installed on the first driving shaft 212, a second drive motor 230 connected to the second main gear 220 and configured to transmit driving power, and a rotary blade 240 installed on the first driving shaft 212 and configured to operate in conjunction with the first driving shaft 212 to supply an external force to the bagged packaging products having uneven shapes formed by the concentrated contents.

In a second embodiment, the dispersion induction unit 200 according to the present disclosure includes first and second driving shafts 212 and 214 installed at predetermined intervals between the first rotary roller 110 and the second rotary roller 120, the second main gear 220 installed on the first driving shaft 212, the second drive motor 230 connected to the second main gear 220 and configured to transmit driving power, driving power transmission gears 252 and 254 each installed at one side distal end of each of the first and second driving shafts 212 and 214, a chain 260 installed to surround the driving power transmission gears 252 and 254 so that the second driving shaft 214 operates in conjunction with a rotation of the first driving shaft 212, and the rotary blades 240 installed on the driving shafts 212 and 214and configured to operate in conjunction with the driving shafts 212 and 214 to supply an external force to the bagged packaging products having uneven shapes formed by the concentrated contents.

The first driving shaft 212 is configured to be axially rotated by driving power transmitted from the second drive motor 230. As illustrated in FIG. 7, the first driving shaft 212 is disposed between the first rotary roller 110 and the second rotary roller 120 and seated on the left and right partition walls. In this case, the first driving shaft 212 may be connected to bearings installed on the left and right partition walls so that the first driving shaft 212 may be axially rotated by the driving power transmitted from the second drive motor 230.

The second driving shaft 214 is configured to be axially rotated by a rotational force transmitted from the first driving shaft 212 through the chain 260. As illustrated in FIG. 7, the second driving shaft 214 is seated on the left and right partition walls and disposed in parallel with the first driving shaft 212. In this case, the second driving shaft 214 may be connected to bearings installed on the left and right partition walls so that the second driving shaft 214 may be axially rotated by a rotational force transmitted from the chain 260.

As necessary, the dispersion induction unit 200 according to the present disclosure may further include a third driving shaft 216. The third driving shaft 216 is configured to be axially rotated by a rotational force transmitted from the first driving shaft 212 through the chain 260. As illustrated in FIG. 7, the third driving shaft 216 is seated on the left and right partition walls and disposed in parallel with the first driving shaft 212 and the second driving shaft 214. In this case, the third driving shaft 216 may be connected to bearings installed on the left and right partition walls so that the third driving shaft 216 may be axially rotated by a rotational force transmitted from the chain 260.

The second main gear 220 is fixed to the first driving shaft 212 to transmit driving power from the second drive motor 230 to the first driving shaft 212. The second main gear 220 may be provided on the first driving shaft 212 and disposed at the outer periphery of the conveyor belt 130. Alternatively, the second main gear 220 may be provided on the first driving shaft 212 and disposed in the conveyor belt 130.

The second drive motor 230 generates driving power and transmits the driving power to the second main gear 220 through a second rotary shaft pulley coupled to a rotary shaft thereof. In this case, the second rotary shaft pulley engages with the second main gear 220 and transmits driving power from the rotary shaft to the second main gear 220.

The driving power transmission gears are each installed at one side distal end of each of the first driving shaft 212, the second driving shaft 214, and the third driving shaft 216 to transmit a rotational force of the first driving shaft 212 to the second driving shaft 214 and the third driving shaft 216. A spur gear or the like may be used as the driving power transmission gear.

For example, the second main gear 220 is installed at one side distal end of the first driving shaft 212 and receives driving power from the second drive motor 230, and a first driving power transmission gear 252 is installed at the other side distal end opposite to one side distal end. In addition, the second driving power transmission gear 254 is installed at the other side distal end so that the second driving shaft 214 is installed on the same line as the first driving power transmission gear 252. Further, the third driving power transmission gear 256 is installed at the other side distal end so that the third driving shaft 216 is disposed on the same line as the first and second driving power transmission gears 252 and 254.

The chain 260 is installed to surround the first driving power transmission gear 252, the second driving power transmission gear 254, and a third driving power transmission gear 256 so that the second driving shaft 214 and the third driving shaft 216 may be rotated in the same direction as the first driving shaft 212 when the first driving shaft 212 rotates.

As necessary, as illustrated in FIG. 4, the dispersion induction unit 200 according to the present disclosure may have a support shaft 270 having a rotary gear and provided separately from the first, second, and third driving shafts 212, 214, and 216 in order to stably maintain tension of the chain 260. In this case, the chain 260 is installed to surround the first, second, and third driving power transmission gears 252, 254, and 256 and the rotary gear.

The rotary blades 240 are installed on the driving shafts 212, 214, and 216 and supply external forces to disperse the contents that are concentrated in partial spaces in the bagged packaging products and cause uneven shapes of the bagged packaging products.

The rotary blade 240 may rotate in a direction opposite to the rotation direction of the conveyor belt 130 to enhance the effect of dispersing the contents. To this end, the second drive motor 230 transmits driving power to the first driving shaft 212 so that the first driving shaft 212 rotates in a direction opposite to the rotation directions of the first and second rotary rollers 110 and 120.

In addition, the rotary blade 240 may have a length shorter than a diameter of each of the first and second rotary rollers 110 and 120 so that the rotary blade 240 does not come into contact with the conveyor belt 130 that is not bent. For example, when the bagged packaging product, in which the contents are uniformly dispersed and do not bend the conveyor belt 130, passes over the belt conveyor 100, the rotary blade 240 and the conveyor belt 130 do not come into contact with each other, thereby preventing damage to the conveyor belt 130. Further, when the bagged packaging product, in which the contents are concentrated and cause an uneven shape of the bagged packaging product, passes over the belt conveyor 100, a region of the bagged packaging product, which exceeds a reference thickness range, is moved to a rotational region of the rotary blade 240 by the pressing unit 300, such that the bagged packaging product collides with the rotary blade 240.

In one embodiment, the rotary blades 240 according to the present disclosure may include straight bars 242 coupled to the driving shafts 212, 214, and 216 and configured to rotate in the same direction as the driving shafts. In this case, a distal end of the straight bar 242, which is configured to come into contact with the conveyor belt 130, may have a hemispherical structure.

In another embodiment, as illustrated in FIGS. 6 and 7, the rotary blade 240 according to the present disclosure may include the straight bar 242 coupled to each of the driving shafts 212, 214, and 216 and configured to rotate in the same direction as the driving shaft, and protection rollers 244 provided at two opposite distal ends of the straight bar 242 and configured to come into contact with the conveyor belt 130 and suppress damage to the conveyor belt 130 when the protection rollers 244 come into contact with the conveyor belt 130.

More specifically, the protection roller 244 may include a head portion formed to have a diameter larger than a diameter of the distal end of the straight bar 242 so that the distal end of the rotating straight bar 242 does not come into direct contact with the conveyor belt 130, and a body portion protruding from a center of the head portion and fitted with the distal end of the straight bar 242.

In this case, a first threaded portion may be formed in a through-hole of the straight bar 242 into which the body portion is inserted, and a second threaded portion, which may be assembled to the first threaded portion, may be formed on an outer peripheral surface of the body portion.

Further, in case that the threaded portion is not formed in the through-hole of the straight bar 242 into which the body portion is inserted, the protection roller 244 may further include a nut portion. The nut portion is assembled to a screw thread formed at a distal end of the body portion and serves to fix the body portion to the straight bar 242.

As necessary, the head portion may have a buffer material, such as rubber or sponge, provided on an outer peripheral surface of the head portion in order to reduce damage to the conveyor belt 130 when the head portion comes into contact with the conveyor belt 130.

As described above, instead of the straight bar 242, the protection roller 244 may come into contact with the conveyor belt 130, thereby providing an effect of minimizing damage to the conveyor belt 130.

The dispersion induction unit 200 according to the present disclosure may have a protection box 280 provided on the left or right partition wall and configured to surround the first driving shaft 212, the second driving shaft 214, the third driving shaft 216, and the chain 260 in order to protect the first driving shaft 212, the second driving shaft 214, the third driving shaft 216, and the chain 260 from dust, external impact, and the like.

With reference to FIGS. 2 to 7, the flattening device for bagged packaging products according to the present disclosure includes the pressing unit 300.

The pressing unit 300 is spaced apart from the belt conveyor 100 and installed on the external frame 400 positioned above the belt conveyor 100. The pressing unit 300 presses the bagged packaging products so that different amounts of pressure are applied to the bagged packaging products depending on vertical thicknesses of the bagged packaging products.

To this end, the pressing unit 300 may be spaced apart from the conveyor belt 130 by a length equal to a reference thickness/length of the bagged packaging product so that the bagged packaging product flattened in a reference state does not come into contact with the dispersion induction unit 200 when the bagged packaging product is transferred by the conveyor belt 130. For example, in case that the vertical thickness of the bagged packaging product flattened in the reference state is 50 mm, the pressing unit 300 may be spaced apart from the conveyor belt 130 by 50 mm and installed on the external frame 400 positioned above the conveyor belt 130.

When an uneven portion of the bagged packaging product transferred by the conveyor belt 130 has a thickness of 80 mm in case that the pressing unit 300 is installed above the conveyor belt 130 and spaced apart from the conveyor belt 130 by 50 mm, as described above, the pressing unit 300 moves the uneven portion downward to 30 mm below a reference line and allows the uneven portion to come into contact with the rotary blade 240. When the thickness of the bagged packaging product transferred by the conveyor belt 130 has a uniform thickness of 50 mm, the pressing unit 300 allows the bagged packaging product to pass in an intact manner without pressing the bagged packaging product in the direction toward the dispersion induction unit 200.

In one embodiment, the pressing unit 300 according to the present disclosure may be configured as a housing capable of pressing the bagged packaging products that move between the pressing unit 300 and the conveyor belt 130.

In another embodiment, the pressing unit 300 according to the present disclosure may include a pressing roller 310 configured to axially rotate to allow the bagged packaging product to smoothly move at a predesignated speed together with the conveyor belt 130. More specifically, the pressing unit 300 may include the pressing roller 310 installed in a direction identical to the width direction of the conveyor, a third main gear 320 installed on the pressing roller 310, and a third drive motor 330 configured to transmit driving power to the third main gear 320 so that the pressing roller 310 rotates in a direction opposite to the rotation directions of the first and second rotary rollers. The pressing roller 310 and the third drive motor 330 are installed in the housing.

The pressing roller 310 is spaced apart from the conveyor belt 130 by a length equal to the reference thickness/length of the bagged packaging product so that the bagged packaging product flattened in the reference state does not come into contact with the dispersion induction unit 200 when the bagged packaging product is transferred by the conveyor belt 130.

The pressing roller 310 may have a buffer cover 315 configured as a sponge or the like and provided on an outer peripheral surface of the pressing roller 310, which is configured to come into contact with the bagged packaging products, thereby preventing damage to the bagged packaging products when the pressing roller 310 comes into contact with the bagged packaging products.

With reference to FIGS. 2 to 5, the flattening device for bagged packaging products according to the present disclosure may further include a rotary rod 500 and a rotary handle 600.

The rotary rod 500 is configured to raise or lower the pressing unit 300 so that an interval between the pressing unit 300 and the conveyor belt 130 is adjusted in accordance with an external force provided from the outside. The rotary rod 500 is assembled to a spiral assembling hole of the external frame 400 and raised or lowered while axially rotating. To this end, a threaded portion is provided on an outer peripheral surface of the rotary rod 500 and corresponds to a threaded portion formed in the spiral assembling hole. In addition, a lower end of the rotary rod 500 is connected to the pressing unit 300, and the rotary rod 500 raises or lowers the pressing unit 300 while axially rotating.

The rotary handle 600 is installed at an upper end of the rotary rod 500 so that an external force of a manager may be smoothly transmitted to the rotary rod 500. The rotary handle 600 is formed to have a diameter larger than a diameter of the rotary rod 500 and determines an axial rotation direction of the rotary rod 500 in accordance with a direction of the external force provided from the manager. For example, when the rotary handle 600 rotates clockwise, the rotary rod 500 also axially rotates clockwise. When the rotary handle 600 rotates counterclockwise, the rotary rod 500 also axially rotates counterclockwise.

While the present disclosure has been described above with reference to the exemplary embodiments, it may be understood by those skilled in the art that the present disclosure may be variously modified and changed without departing from the spirit and scope of the present disclosure disclosed in the claims.

1-8. (canceled)

9. A flattening device for bagged packaging products, the flattening device comprising:
a belt conveyor comprising a first rotary roller installed at a front end of the conveyor and installed in a width direction of the conveyor, a second rotary roller installed rearward of the first rotary roller and installed in parallel with the first rotary roller, a conveyor belt installed to surround the first rotary roller and the second rotary roller, a first main gear installed on the first rotary roller or the second rotary roller, and a first drive motor connected to the first main gear and configured to transmit driving power;
a dispersion induction unit installed in the belt conveyor and configured to supply an external force so that contents in a bagged packaging product transferred by the conveyor belt are dispersed in the bagged packaging product; and
a pressing unit installed above the belt conveyor, spaced apart from the belt conveyor, and configured to press the bagged packaging product, which is transferred by the belt conveyor, in a direction toward the dispersion induction unit.

10. The flattening device of claim 9, wherein the dispersion induction unit comprises:
a first driving shaft installed at a predetermined interval between the first rotary roller and the second rotary roller;
a second main gear installed on the first driving shaft;
a second drive motor connected to the second main gear and configured to transmit driving power; and
a rotary blade installed on the first driving shaft and configured to operate in conjunction with the first driving shaft to supply an external force to the bagged packaging product having an uneven shape formed by concentrated contents.

11. The flattening device of claim 9, wherein the dispersion induction unit comprises:
first and second driving shafts installed at predetermined intervals between the first rotary roller and the second rotary roller;
a second main gear installed on the first driving shaft;
a second drive motor connected to the second main gear and configured to transmit driving power;
driving power transmission gears each installed at one side distal end of each of the first and second driving shafts;
a chain installed to surround the driving power transmission gears so that the second driving shaft operates in conjunction with a rotation of the first driving shaft; and
rotary blades installed on the driving shafts and configured to operate in conjunction with the driving shafts to supply external forces to the bagged packaging product having an uneven shape formed by concentrated contents.

12. The flattening device of claim 10, wherein the rotary blade is formed to have a length shorter than a diameter of each of the first and second rotary rollers so that the rotary blade does not come into contact with the conveyor belt that is not bent.

13. The flattening device of claim 11, wherein the rotary blade is formed to have a length shorter than a diameter of each of the first and second rotary rollers so that the rotary blade does not come into contact with the conveyor belt that is not bent.

14. The flattening device of claim 10, wherein the rotary blade comprises:
a straight bar coupled to the driving shaft and configured to rotate in the same direction as the driving shaft; and
protection rollers provided at two opposite distal ends of the straight bar and configured to come into contact with the conveyor belt to suppress damage to the conveyor belt when the protection rollers come into contact with the conveyor belt.

15. The flattening device of claim 11, wherein the rotary blade comprises:
a straight bar coupled to the driving shaft and configured to rotate in the same direction as the driving shaft; and
protection rollers provided at two opposite distal ends of the straight bar and configured to come into contact with the conveyor belt to suppress damage to the conveyor belt when the protection rollers come into contact with the conveyor belt.

16. The flattening device of claim 9, wherein the pressing unit comprises:
a pressing roller installed in a direction identical to the width direction of the conveyor;
a third main gear installed on the pressing roller; and
a third drive motor configured to transmit driving power to the third main gear so that the pressing roller rotates in a direction opposite to rotation directions of the first and second rotary rollers.

17. The flattening device of claim 16, wherein the pressing roller is spaced apart from the conveyor belt by a length equal to a reference thickness/length of the bagged packaging product so that the bagged packaging product flattened in a reference state does not come into contact with the dispersion induction unit when the bagged packaging product is transferred by the conveyor belt.

18. The flattening device of claim 9, further comprising:
an external frame configured to provide an installation space for the belt conveyor and the dispersion induction unit and having a spiral assembling hole formed at an upper end thereof;
a rotary rod assembled to the spiral assembling hole, having a lower end connected to the pressing unit, and configured to raise or lower the pressing unit while axially rotating; and
a rotary handle installed at an upper end of the rotary rod and configured to transmit an external force to the rotary rod so that the rotary rod axially rotates.

19. The flattening device of claim 11, wherein the dispersion induction unit further comprises:
a third driving shaft arranged in parallel with the first and second driving shafts; and
a third driving power transmission gear provided at one side distal end of the third driving shaft,
wherein the chain is disposed to surround the first and second driving power transmission gears and the third driving power transmission gear, and rotary blades are mounted on the first, second, and third driving shafts.

20. The flattening device of claim 17, wherein the dispersion induction unit further comprises a support shaft having a rotary gear, and the chain is disposed to surround the first, second, and third driving power transmission gears and the rotary gear of the support shaft.

21. The flattening device of claim 12, wherein each of the protection rollers comprises a head portion, and a buffer material is provided on an outer peripheral surface of the head portion.

14. The flattening device of claim 13, wherein each of the protection rollers comprises a head portion, and a buffer material is provided on an outer peripheral surface of the head portion.

15. The flattening device of claim 14, wherein the pressing roller further comprises a buffer cover provided on an outer peripheral surface thereof.
